(19) United States
(12) Patent Application Publication
(10) Pub. No.: US 2026/0193767 A1
(43) Pub. Date: Jul. 9, 2026

(54) METHOD FOR PRODUCING A NITRIDED PART OF AN AIRCRAFT TURBOMACHINE

(71) Applicants: SAFRAN, Paris (FR); SAFRAN TRANSMISSION SYSTEMS, Colombes (FR)

(72) Inventors: Damien HERISSON, MOISSY-CRAMAYEL (FR); Khalil TRAIDI, MOISSY-CRAMAYEL (FR); Charlie Sorak POULAT, MOISSY-CRAMAYEL (FR); Romain GUIHEUX, MOISSY-CRAMAYEL (FR); François NICOLAIE, MOISSY-CRAMAYEL (FR); Mathilde MILLOT, MOISSY-CRAMAYEL (FR)

(73) Assignees: SAFRAN, Paris (FR); SAFRAN TRANSMISSION SYSTEMS, Colombes (FR)

(21) Appl. No.: 19/132,975

(22) PCT Filed: Dec. 8, 2023
(86) PCT No.: PCT/FR2023/051964

§ 371 Date: May 27, 2025

(30) Foreign Application Priority Data
Dec. 9, 2022 (FR) FR2213094

(51) Int. Cl. C23C 8/26; C23C 8/02; C23C 8/80; F16H 55/06; F16H 55/17

(52) U.S. Cl. CPC C23C 8/26; C23C 8/02; C23C 8/80; F16H 55/06; F16H 55/17

(57) ABSTRACT

A method for producing a nitrided steel part in which a semi-finished blank made of nitriding steel is produced from a blank or a steel bar and in which a reinforcing treatment is carried out on the semi-finished blank thus obtained, the method including a preliminary heat treatment in which the blank or steel bar from which said semi-finished blank is obtained is heat-treated beforehand. The preliminary heat treatment includes a hardening treatment by a heating which ensures austenitization of the steel and a tempering treatment at a temperature between 200° C. and 650° C. A surface induction hardening is performed on the semi-finished blank prior to a step of shallow nitriding, the step of shallow nitriding being carried out for a period of less than 250 hours, at a temperature of between 400° C. and 600° C.

### GENERAL TECHNICAL FIELD AND PRIOR ART

The present invention relates to the general field of producing a nitrided steel part.

Nitriding of low-alloy steels is a conventional solution for many parts, in particular power transmission parts in aircraft turbomachinery (gear teeth, splined shafts, bearings, crowns, etc.) whose operating temperature does not allow the use of case-hardened steels.

To ensure the expected mechanical resistance, these parts must have very high hardnesses over depths of up to 2 or 3 times the depth of the stressed sub-layer.

This quality and depth of hardening can be achieved with steels including alloying elements that allow hardening by nitriding.

Nitriding consists of the diffusion of atomic nitrogen N onto the surface of parts previously treated by hardening and tempering (N and C for nitrocarburizing). The insertion of N (or N and C), the formation of nitrides with the alloying elements of the steel, causes a surface hardening providing the desired properties (hardness and corrosion resistance).

However, due to the diffusion kinetics of nitrogen, the nitriding treatments required to achieve reinforcement depths compatible with the applications mentioned above (penetration depth greater than 1 mm) are generally long (typically, more than 500 hours). These long treatments are difficult to reconcile with industrial production rates and are expensive.

### GENERAL PRESENTATION OF THE INVENTION

In order to facilitate industrialization, one purpose of the invention is to propose a production method with a reduced reinforcement treatment time, while still allowing the required resistance properties to be retained.

In particular, according to one aspect, the invention proposes a method for producing a nitrided steel part in which a semi-finished blank made of nitriding steel is produced and a reinforcing treatment is carried out on the semi-finished blank thus obtained, comprising a nitriding step, said blank or a steel bar from which said blank is obtained being heat-treated beforehand,
wherein, prior to the step of nitriding performed as part of the reinforcing treatment, an induction hardening step is carried out on the semi-finished blank, the nitriding that is subsequently carried out being shallow nitriding carried out for a period of less than 250 hours (preferably less than 150 hours and even more preferably less than 100 hours) at a temperature of between 400° C. and 600° C. (preferentially between 450° C. and 550° C.).

This solution allows to drastically reduce cycle times from a few hundred hours to a few dozen hours.

The combination of a surface induction treatment, followed by a proposed nitriding treatment (shallow depth nitriding) allows to considerably reduce the nitriding time required to obtain the desired mechanical properties.

Induction allows rapid treatment over a significant depth (>1 mm) in accordance with current design constraints (2 to 3 times the maximum loading depth).

Shallow nitriding further increases surface hardness and therefore resistance to surface fatigue and bending, particularly at the root of the tooth for a set of teeth.

Thus, the reinforcing treatment ensures resistance to sub-layer fatigue (location of maximum loading), surface fatigue (micro-chipping) and bending at the tooth root.

Moreover, the distortions related to the reinforcing treatment are less compared to deep nitriding alone, which facilitates the production of parts and allows to reduce the thickness of material to be reworked during final machining (economic savings on material and limitation of intervention times related to the reworking of the part at the end of production (from several hundred um to several tens of um of thickness reworked on the post-treatment part)).

The proposed method is advantageously supplemented by the following characteristics.

The nitriding steel includes nitriding alloying elements and a carbon content comprised between 0.20% and 0.45%, preferably greater than 0.25%.

The depth of the nitriding layer is less than 1.5 mm and is preferably comprised between 0.1 mm and 1 mm and even more preferably between 0.2 and 0.8 mm.

The preliminary heat treatment carried out on a blank or on a steel bar from which said blank is obtained is, for example, a hardening and tempering treatment.

Also, surface preparation by sandblasting and/or phosphating is preferably carried out prior to the nitriding step.

Moreover, a finishing operation is advantageously carried out on the part obtained by grinding and/or electrochemical polishing and/or tribofinishing.

The part is advantageously a power transmission part of an aircraft turbomachine, such as a toothed or splined part, a pinion part, a bearing track, etc.

In addition to saving treatment time, the combined induction and nitriding treatment ensures that the sub-layer is sufficiently resistant to fatigue, and improves resistance to surface fatigue (micro-chipping) and to bending at the tooth root.

It should also be noted that using nitriding after induction minimizes residual austenite, which is an important characteristic in aeronautical applications, since residual austenite can have an impact on geometric distortions and on the metallurgical instability of the part.

The intervention of nitriding after induction also allows to avoid the generation of nitrogen ferrite.

This process also allows for more constraints near the surface as well as an accumulation of residual stress profiles related to the two treatments. All of this is favorable for resistance to contact fatigue and bending fatigue, particularly at the tooth root.

Furthermore, induction generates fresh martensite after hardening. Such generation normally requires a tempering treatment: which is in this case incorporated into the nitriding step. No additional tempering step is then necessary.

### BRIEF DESCRIPTION OF THE DRAWINGS

Other characteristics and advantages of the invention will emerge from the following description, which is purely illustrative and non-limiting, and must be read in conjunction with the appended figures in which:

FIG. 1 is a schematic sectional representation of two meshing wheels of a power transmission gear;

FIG. 2 schematically illustrates a set of teeth of the wheels of the gear of FIG. 1;

FIG. 3 illustrates the expected hardness profile after the surface hardening treatment followed by nitriding, with the acceptable limits in hardness and treatment depth also being indicated.

### DESCRIPTION OF ONE OR MORE IMPLEMENTATIONS AND EMBODIMENTS

### Parts and Applications

Generally speaking, the proposed method applies advantageously to any part with maximum loading constraint in the sub-layer.

It is particularly advantageous in the field of aeronautics and in particular for the reinforcement of power transmission parts of the toothed and/or splined type, gears (pinions in particular), raceways, etc. in aircraft turbomachines.

More generally, it can be applied to all parts which have to undergo a severe thermal environment and which are subjected to high mechanical stress on the surface (bending fatigue, contact fatigue, fretting, wear, etc.).

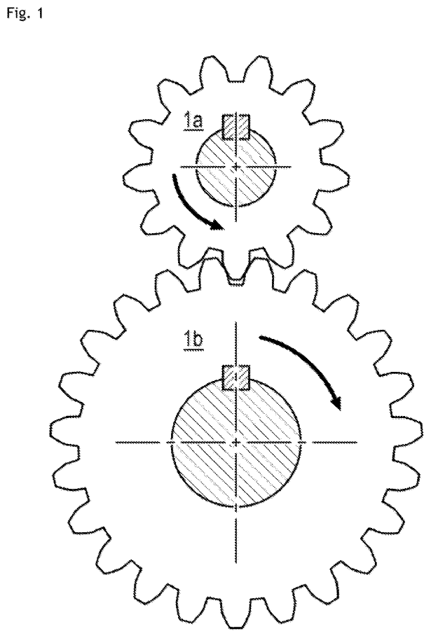

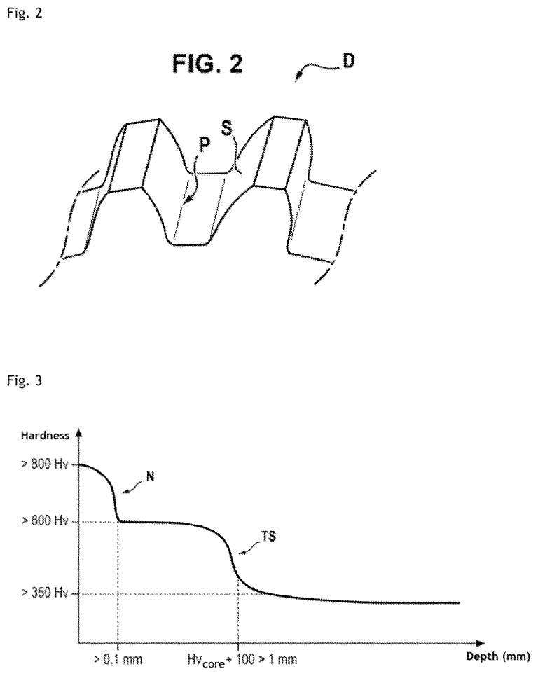

FIG. 1 shows two wheels 1a, 1b of a cylindrical gear E with straight teeth and FIG. 2 shows a set of teeth D of one of the wheels 1a or 1b of this gear E.

Such teeth are subject to both bending fatigue stresses at the tooth root (area P) and surface pressure stresses likely to generate chipping at the contact surface of the teeth (area S) or even to cause tooth breakage.

Parts 1a and 1b may be produced by the method as described below which provides hardness and bending strength compatible with the gear application.

### Alloys

The part produced by the proposed method is made of a low-alloy nitriding steel with nitriding alloy elements such as Cr, V, Mo and Al, (non-exhaustive list) allowing hardening by nitriding (precipitation of submicroscopic nitrides from these nitriding elements, present in solid solution in the treated steel, etc.).

Such a nitriding steel typically has a carbon content of between 0.15% and 0.8%, preferably between 0.15% and 0.65%, allowing the base material to obtain its core mechanical properties after heat treatment.

Examples of such steels are: 32CDV13 (33CrMoV12-9), 40CDV12 (40CrMoV13-9), 300M steel, etc.

The production of the part involves producing a blank of the part from this steel, a heat treatment of this blank, then a semi-finishing of the rough part. The semi-finished part 5 obtained is then subjected to induction hardening, then to shallow nitriding.

### Producing a Blank

In the first step, a blank of the steel part is produced to give a first shape to the part in question.

This blank is obtained by successive steps of “rough” machining on a steel bar. These steps allow the general shape of the part to be obtained. At this stage, surplus material (approximately 0.5 mm of the minimum dimensions) is kept on the surface for the subsequent phase of finishing machining, which allows the desired final dimensions of the part to be achieved (step 1).

Other techniques for obtaining a blank could of course also be considered:
additive manufacture in particular, in the case of parts with complex shapes.

### Heat Treatment of the Blank or Steel

The blank thus produced is subjected to heat treatment, by hardening and tempering.

The hardening treatment ensures austenitization of the steel. It is carried out by heating to a temperature of between 800° C. and 1200° C., typically between 900° C. and 1100° C. for a few hours.

Tempering takes place at a temperature of between 200° C. and 650° C., typically between 520° C. and 650° C. for a few hours, for example 620° C. for 2 to 4 hours.

Alternatively, it may be provided that the treatment of hardening and tempering of the blank takes place before machining of the blank, on the steel bar.

### Induction Hardening

Electromagnetic induction hardening provides uniform, rapid heating over a controlled and reproducible depth of 1 mm to several centimetres.

Induction hardening can be carried out on all teeth simultaneously or locally, for example tooth by tooth. In induction hardening on all teeth simultaneously, the part is placed inside a single-turn or multi-turn inductor coaxially surrounding the part and traversed by a high, medium or low frequency alternating current. This inductor behaves like a transformer with the part and develops an induced current therein. The alternating magnetic field in the part heats the outer surface.

In the case of localized hardening, the area of interest is heated with an inductor through which an alternating current flows.

The power delivered is chosen to be sufficient to ensure austenitization over the desired functional depth.

For contour hardening on a set of teeth, the supplying alternating field is typically high frequency (10 to 600 kHz), with a current generator with a power greater than 10 kW.

Other frequencies and powers are of course possible depending on the desired reinforcement depth.

Since the heating effect at the periphery of the part is very rapid, the duration of the induction can be short: a few tenths of a second to a few seconds.

This treatment allows for example a hardness of up to 700 HV-(Vickers hardness)) over a great depth (>1 mm).

Typically, the hardness obtained is 600 HV for 32CDV13 and 700 HV for 40CDV12.

### Surface Preparation for Nitriding

This nitriding treatment is preceded by surface preparation by sandblasting and/or phosphating.

### Shallow Nitriding

This hardening treatment is followed by a shallow nitriding treatment (step 3b).

Nitriding can, conventionally, consist of immersing the part in an environment capable of releasing nitrogen on the surface, at a temperature allowing the nitrogen to diffuse from the surface to the core of the part.

This nitriding can be gas, ionic or salt bath nitriding.

It operates at fairly low temperatures (between 400° C. and 600° C. and preferably below 500° C. to avoid losing the advantage provided by induction treatment).

The duration is limited (around ten or a few dozen hours −20 to 30 hours, for example, and in any case less than 100 hours (preferably less than 50 hours)) and depends on the depth of the total nitriding layer desired, the nitriding conditions and the intended applications.

For examples of nitriding methods, reference can advantageously be made to the thesis

TS O. Skiba “Development of a nitriding method for aeronautics. Study of hardening mechanisms on nitrided iron-chromium alloys”.

In practice, however, nitriding can be chosen depending on industrial applications and the functional need for reinforcing the mechanical material on the subsurface.

Typically, the depth of the nitriding layer can reach up to 1.5 mm. It is preferably comprised between 0.1 mm and 1 mm and even more preferably between 0.2 and 0.8 mm.

The hardness level obtained is higher than that at the output of the induction hardening step (typically higher than 800 HV).

This is illustrated in FIG. 3: the surface hardening treatment allows hardnesses of 600 HV or higher (part of the TS curve); the additional nitriding increases this hardness and allows values higher than 800 HV.

### Finishing Operations

A finishing step is then planned, followed by a superfinishing step.

The finishing step consists, for example, of re-machining to correct geometric distortions and a possible white layer.

It is notable that with the proposed method, this finishing step generates fewer material chips (from the order of a hundred um to the order of ten um).

In fact, it is observed that induction generates fewer geometric changes than deep nitriding.

This finishing step can then be followed by a superfinishing step, which for example uses electrochemical polishing and/or tribofinishing in a bath of granules, in order to give the desired surface finish to the part.

The part resulting from the method is distinguished from that obtained by a conventional method by typical percentages of Carbon and Nitrogen due to the method. The absence of Carbon gradient in the area resulting from induction hardening (unlike carburizing) can be observed.

1: A method for producing a nitrided steel part in which a semi-finished blank made of nitriding steel is produced from a blank or a steel bar and in which a reinforcing treatment is carried out on the semi-finished blank thus obtained,
wherein said method comprises preliminary heat treatment in which the-blank or a steel bar from which said semi-finished blank is obtained is heat-treated beforehand,
said preliminary heat treatment comprising:
a hardening treatment by a heating which ensures austenitization of the steel and
a tempering treatment at a temperature between 200° C. and 650° C.,
wherein a surface induction hardening is performed on the semi-finished blank prior to a step of shallow nitriding, the step of-shallow nitriding being carried out for a period of less than 250 hours, at a temperature of between 400° C. and 600° C.

2: The method according to claim 1, wherein the nitriding step lasts less than 150 hours.

3: The method according to claim 2, wherein the nitriding step lasts less than 100 hours.

4: The method according to claim 1, wherein the nitriding step is performed at a temperature is comprised between 450° C. and 550° C.

5: The method according to claim 1, wherein a nitriding steel from which the a semi-finished blank is made includes nitriding alloying elements and a carbon content comprised between 0.15% and 0.8%, preferably between 0.15% and 0.65%.

6: The method according to claim 1, wherein the nitriding step is performed on a nitriding depth which is less than 1.5 mm and which is preferably comprised between 0.1 mm and 1 mm.

7: The method according to claim 1, wherein the preliminary heat treatment carried out on a blank or on a steel bar from which said blank is obtained, is a hardening and tempering treatment.

8: The method according to claim 1, wherein, a surface preparation by sandblasting and/or phosphating is carried out prior to the nitriding step.

9: The method according to claim 1, wherein a finishing operation is carried out on the nitrided steel part, said polishing operation being performed through grinding and/or electrochemical polishing and/or tribofinishing.

10: The method according to claim 1, wherein the nitrided steel part is toothed, said nitrided steel part comprising teeth and wherein the induction hardening step takes place on all the teeth simultaneously or locally.

11: A power transmission part of an aircraft turbomachine, said power transmission part being a nitrided steel part made of nitriding steel and produced from a blank or a steel bar, a reinforcing treatment being carried out on the semi-finished blank thus obtained,
wherein said semi-finished blank is heat-treated beforehand in a preliminary heat treatment, said preliminary heat treatment comprising:
a hardening treatment by a heating which ensures austenitization of the steel and
a tempering treatment at a temperature between 200° C. and 650° C.,
and wherein said nitrided steel part presents an induction hardened and shallow niitrided surface, the surface induction hardening being performed on the semi-finished blank prior to a step of shallow nitriding, the step of shallow nitriding being carried out for a period of less than 250 hours, at a temperature of between 400° C. and 600° C.
